(19) United States
(12) Patent Application Publication
(10) Pub. No.: US 2023/0163438 A1
(43) Pub. Date: May 25, 2023

(54) SIGNAL TRANSMISSION SYSTEM AND DIELECTRIC WAVEGUIDE

(71) Applicant: Molex, LLC, Lisle, IL (US)

(72) Inventors: Hiroyuki YAJIMA, Yamato (JP); Nobumasa MOTOHASHI, Yamato (JP); Akihiro SHIMOTSU, Yamato (JP)

(73) Assignee: Molex, LLC, Lisle, IL (US)

(21) Appl. No.: 17/987,876

(22) Filed: Nov. 16, 2022

(30) Foreign Application Priority Data
Nov. 19, 2021 (JP) 2021-188763

(51) Int. Cl. H01P 3/16; H01P 3/12

(52) U.S. Cl. CPC H01P 3/16; H01P 3/121

(57) ABSTRACT

A signal transmission system 1a is mounted on circuit boards 10A and 10B and on circuit boards 10A and 10B and includes semiconductor packages 12A and 12B containing an RF circuit as well as a dielectric waveguide 21E. The semiconductor packages 12A and 12B include the package surface 12f and the antenna 12e formed on the package surface 12f. The dielectric waveguide 21E includes a waveguide end surface 21a facing antenna 12e. An air gap G is ensured between the waveguide end surface 21a and the antenna 12e.

### RELATED APPLICATIONS

This application claims priority to Japanese Patent Application Serial No. 2021-188763 filed on Nov. 19, 2021, which is incorporated herein by reference in its entirety.

### TECHNICAL FIELD

The present disclosure relates to a signal transmission system that transmits signals via a dielectric waveguide.

### BACKGROUND

Patent Document 1 noted below discloses a signal transmission device having two circuit boards where millimeter wave signals are transmitted and received between the two circuit boards via a dielectric waveguide. The dielectric waveguide is electromagnetically coupled to a semiconductor chip via an antenna that is a transmission path coupling part.
Prior Art Documents: Patent Documents: Patent Document 1: WO 2012/111484.

### SUMMARY

For the device disclosed in Patent Document 1, reduction in energy losses during signal transmission via the dielectric waveguide is desirable.

(1) An example of a signal transmission system proposed in the present disclosure includes a circuit board, a semiconductor package including an RF circuit mounted on the circuit board, and a dielectric waveguide. The semiconductor package includes a package surface and an antenna formed on the package surface. The dielectric waveguide includes a waveguide end surface facing the antenna. An air gap is ensured between the waveguide end surface and the antenna. With this system, the air gap can reduce insertion losses.

(2) The signal transmission system of (1) may have at least one support part that supports the dielectric waveguide on the circuit board and ensures the air gap. Thus, the relative position between the antenna and the dielectric waveguide can be optimized.

(3) In the signal transmission system of (2), the at least one support part may be formed on the dielectric waveguide. Herein, the number of parts can be reduced.

(4) In the signal transmission system in (2), where the at least one support part includes two support parts positioned on mutually opposite sides of the semiconductor package. Thus, the support stability of the dielectric waveguide can be ensured.

(5) In the signal transmission system of (1), the air gap may be 0.025 mm or more and 0.5 mm or less. Thus, insertion losses can be reliably reduced by the air gap.

(6) An example of a dielectric waveguide according to the present disclosure includes:

a waveguide main body;
a waveguide end surface for facing the antenna formed on the surface of a semiconductor package, which is an end surface of the waveguide main body in the extending direction of the waveguide main body; and
at least one support part extending beyond the waveguide end surface that ensures an air gap between the antenna supported on a circuit board on which the semiconductor package is mounted and the waveguide end surface.

### BRIEF DESCRIPTION OF THE DRAWINGS

FIG. 1 is a block diagram illustrating an example of a signal transmission system proposed in the present disclosure.

FIG. 2A is a front view illustrating a first example of a signal transmission system.

FIG. 2B is a perspective view illustrating a connecting part provided on the signal transmission system illustrated in FIG. 2A.

FIG. 2C is a perspective view of the signal transmission system illustrated in FIG. 2A.

FIG. 2D is a cross-sectional view of a signal transmission system obtained along the IId-IId line illustrated in FIG. 2C.

FIG. 3 is a graph illustrating the relationship between an air gap and insertion losses.

FIG. 4A is a perspective view illustrating a second example of a signal transmission system.

FIG. 4B is a cross-sectional view of a signal transmission system obtained along the IVa-IVa line in FIG. 4A.

FIG. 5 is a cross-sectional view illustrating a third example of a signal transmission system.

FIG. 6 is a cross-sectional view illustrating a fourth example of a signal transmission system.

FIG. 7A is a perspective view illustrating a fifth example of a signal transmission system.

FIG. 7B is a cross-sectional view of the signal transmission system obtained along the VIIb-VIIb line illustrated in FIG. 7A.

FIG. 8 is a cross-sectional view illustrating a sixth example of a signal transmission system.

FIG. 9A is a side view illustrating a seventh example of a signal transmission system.

FIG. 9B is a perspective view of the signal transmission system illustrated in FIG. 9A.

FIG. 9C is a perspective view illustrating the arrangement of relay fittings in the signal transmission system illustrated in FIG. 9A.

FIG. 9D is a cross-sectional view of a signal transmission system obtained along the IXd-IXd line illustrated in FIG. 9A.

FIG. 10A is a side view illustrating an eighth example of a signal transmission system.

FIG. 10B is a perspective view illustrating the arrangement of relay fittings in the signal transmission system illustrated in FIG. 10A.

### DETAILED DESCRIPTION OF THE PREFERRED EMBODIMENTS

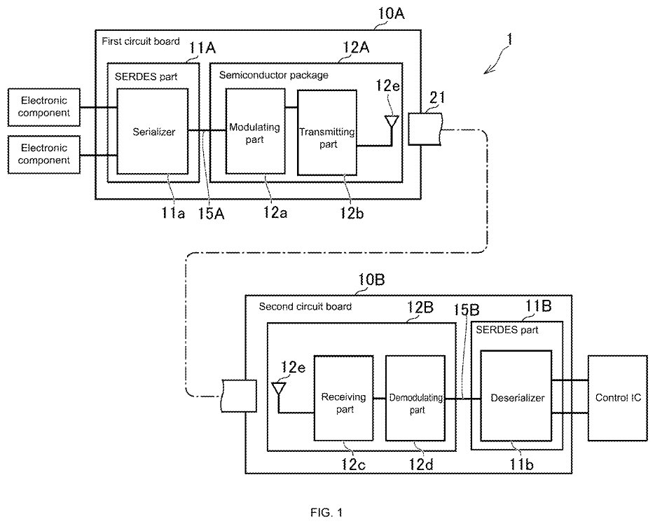

A description is provided for a transmission system proposed by the present disclosure. FIG. 1 is a diagram illustrating a signal transmission system 1 as an example of a signal transmission system proposed by the present disclosure. The signal transmission system 1 includes portable terminals (for example a smartphone), personal computers, a server device, a game device, and the like but is not necessarily limited thereto.

The signal transmission system 1 has a first circuit board 10A and a second circuit board 10B. The circuit boards 10A and 10B are so-called rigid circuit boards such as a glass epoxy board, a composite board with paper epoxy and glass epoxy as a base material, an alumina board, or the like. The circuit boards 10A and 10B may be a Flexible Printed Circuit (FPC) composed of resin such as polyimide, polyester, or the like.

The signal transmission system 1 has a dielectric waveguide 21. High frequency signals are transmitted and received between the first circuit board 10A and the second circuit board 10B via the dielectric waveguide 21. In the present specification, “high frequency” means millimeter waves (28 GHz to 300 GHz) and sub-millimeter waves (300 GHz or higher).

The first circuit board 10A is provided with a semiconductor package 12A and an antenna 12e. The second circuit board 10B is provided with a semiconductor package 12B and antenna 12e. In addition, a SerDes part 11A may be provided on the first circuit board 10A and a SerDes part 11B may be provided on the second circuit board 10B.

The SerDes part 11A of the first circuit board 10A may have a serializer 11a. The SerDes part 11B of the second circuit board 10B may have a deserializer 11b. Digital signals are input into the serializer 11a through one or a plurality of electronic components built-in to the signal transmission system 1.

For example, as illustrated in FIG. 1, a plurality of electronic component output signals (digital signals) are input to the serializer 11a. The electronic component may be, for example, a sensor. Specifically, the electronic component may be an acceleration sensor built-in to the signal transmission system 1 or a temperature sensor to detect the temperature of a battery (not shown) built-in to the signal transmission system 1. The electronic component may be a Wi-Fi (registered trademark) wireless communication module, a communication module for a mobile communication system (for example, 5th generation mobile communication system), or a Global Navigation Satellite System (GNSS) receiver. An output signal of an electronic component may be input to the serializer 11a via an A/D converter (not shown).

The serializer 11a, for example, collects and serializes the output signals of the plurality of electronic components. In other words, the serializer 11a generates a series of serial signals containing the output signals of a plurality of electronic components. The deserializer 11b of the SerDes part 11B receives the serialized output signals of electronic components via the dielectric waveguide 21, separates the plurality of output signals that were serialized, and outputs the signals.

A parallel signal may be input from one electronic component to the serializer 11a. The serializer 11a may then convert this parallel signal into a serial signal. For example, the electronic component may be an image sensor (for example, a CMOS image sensor). A parallel signal may be input from various sensors to the serializer 11a, and the serializer 11a may convert these parallel signals into a serial signal. In this case, the deserializer 11b may convert the serial signals received via the dielectric waveguide 21 to the original parallel signals and output the signals.

The output of the deserializer 11b is input to another electronic component built-in to the signal transmission system 1. Electronic components that acquire signals from the deserializer 11b may be, for example, a control IC including a CPU (Central Processing Unit) or memory.

Differing from the example shown in FIG. 1, the SerDes part 11A of the first circuit board 10A may have a deserializer in addition to the serializer 11a. In this case, the SerDes part 11B of the second circuit board 10B may have a serializer in addition to the deserializer 11b.

As illustrated in FIG. 1, the SerDes part 11A (serializer 11a) is connected to the semiconductor package 12A on the first circuit board 10A via a differential transmission line 15A formed on the first circuit board 10A. In a similar manner, the SerDes part 11B (deserializer 11b) is connected to the semiconductor package 12B on the second circuit board 10B via a differential transmission line 15B formed on the second circuit board 10B. The differential transmission lines 15A and 15B may be microstrip lines or strip lines.

As illustrated in FIG. 1, the semiconductor package 12A may have a modulating part 12a and a transmitting part 12b. In addition, the semiconductor package 12B may have a receiving part 12c and a demodulating part 12d as an RE circuit.

A serial signal (baseband signal) from the serializer 11a is input to the modulating part 12a. The modulating part 12a modulates the input serial signal and then outputs the signal. The transmitting part 12b includes a voltage controlled oscillator (VCO), a mixer, a power amplifier, and the like. Furthermore, the transmitting part 12b multiplies the modulated signal and the output signal of the voltage controlled oscillator, generates (up-converts) a high frequency RF signal (RF signal with a millimeter wave frequency), and outputs this to the antenna 12e as a RF signal.

The antenna 12e of the semiconductor package 12A converts the RF signal (electrical signal) input from the transmitting part 12b into radio waves and emits this towards the dielectric waveguide 21. In addition, the antenna 12e of the semiconductor package 12B converts the electrical signal received from the dielectric waveguide 21 to an RF signal (electrical signal) and outputs this towards the receiving part 12c. As described below, the antenna 12e may be formed on the surface (package surface) of the semiconductor packages 12A and 12B.

The receiving part 12c includes an amplifier, a bandpass filter, a mixer, and a voltage controlled oscillator (VCO), amplifies the RF signal input from the antenna 12e, and multiplies the output signal of the voltage controlled oscillator and the RF signal to lower (down convert) the frequency of the high frequency RF signal. Furthermore, the receiving part 12c then outputs the RF signal with lowered frequency to the demodulating part 12d. The demodulating part 12d demodulates the RF signal and outputs a serial signal (baseband signal).

Unlike the example illustrated in FIG. 1, the SerDes part 1I A of the first circuit board 10A may have a deserializer and the SerDes part 11B of the second circuit board 10B may have a serializer. In this case, the semiconductor package 12B of the second circuit board 10B may have a modulating part 12a and a transmitting part 12b in addition to the receiving part 12c and the like. In addition, the semiconductor package 12A of the first circuit board 10A may have a receiving part 12c and a demodulating part 12d in addition to the transmitting part 12b and the like. In addition, unlike the example illustrated in FIG. 1, the semiconductor package 12A may have SerDes part 11A. In other words, an RF circuit containing a modulating part 12a and transmitting part 12b may be packaged with the serializer 11a (and deserializer). Similarly, the semiconductor package 12B may have SerDes part 11B. In other words, an RF circuit containing the receiving part 12c and the demodulating part 12d may be packaged with the deserializer 11b (and serializer).

The dielectric waveguide 21 may be formed of, for example, liquid crystal polymer resin (LCP resin), polyphenylene sulfide resin (PPS resin), polyamide, polybutylene terephthalate, or the like resin. The dielectric waveguide 21 may be flexible. In this case, a degree of freedom in the positions of the two circuit boards 10A and 10B can be ensured. In addition, by using a dielectric as the waveguide 21 as compared to, for example, a metal waveguide (or waveguide tube), there is an increased degree of freedom of the positions of circuit boards 10A and 10B as well as a reduced manufacturing cost. The thickness of the dielectric waveguide 21 is adapted to the millimeter wave frequency that is transmitted and received between the semiconductor packages 12A and 12B. The cross section of the dielectric waveguide 21 is, for example, rectangular.

The arrangement and support structure of the dielectric waveguide will be described below. In the following description that is applicable to both the two semiconductor packages 12A and 12B, the explanatory code 12 will be used for these semiconductor packages 12A and 12B. In addition, in the following description that is applicable to both the two circuit boards 10A and 10B, the explanatory code 10 will be used for these circuit boards 10A and 10B.

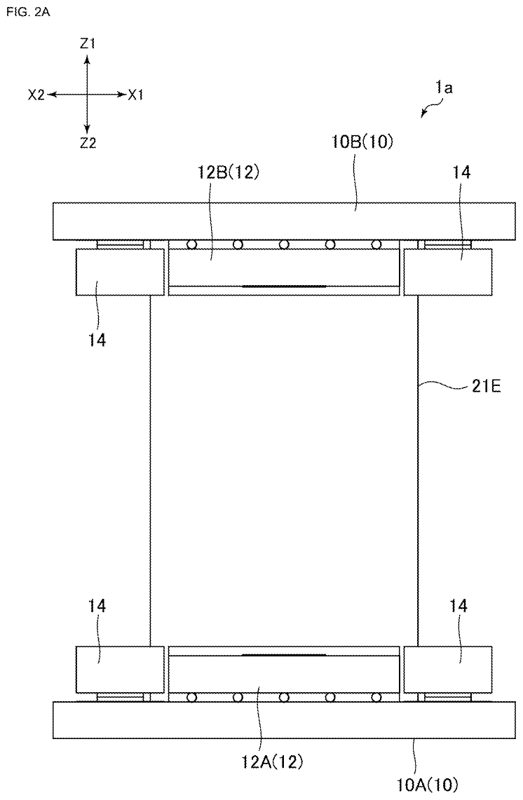

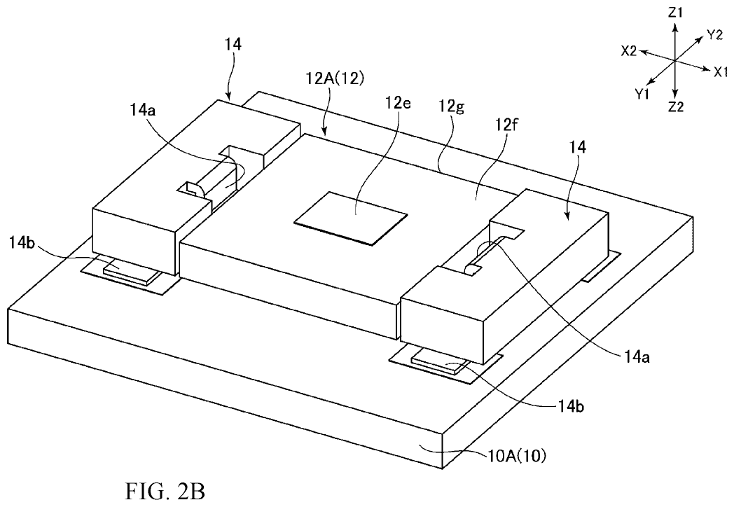

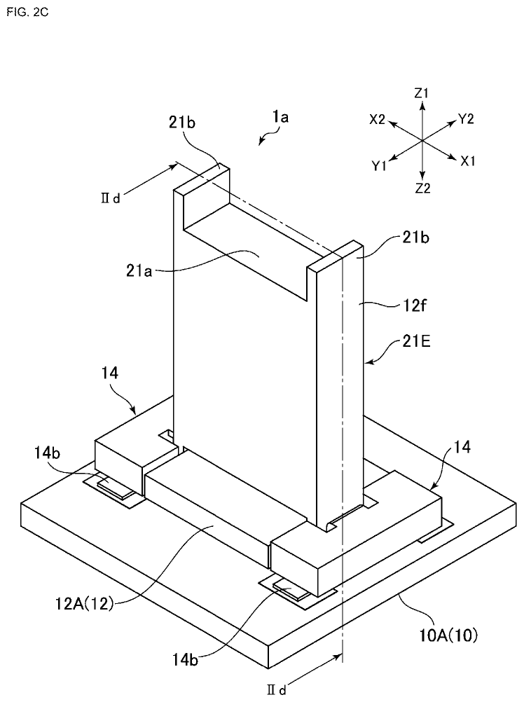

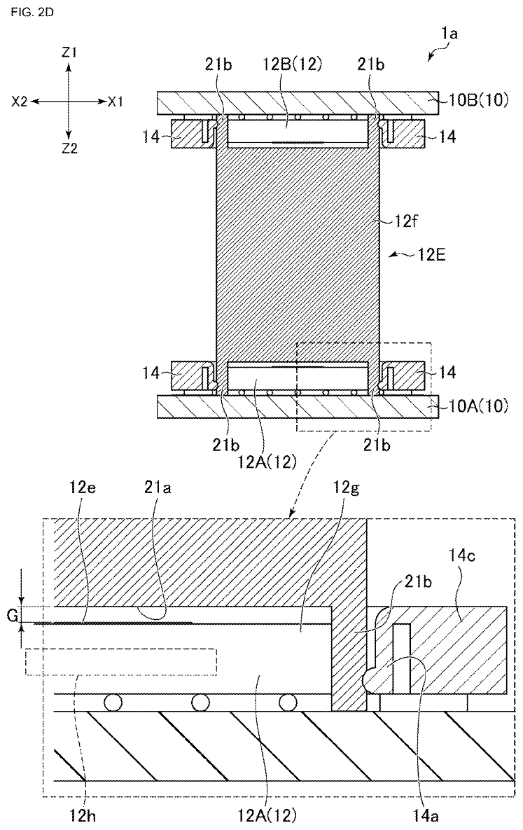

FIG. 2A to FIG. 2D are figures that illustrate a signal transmission system 1a that is an example of the signal transmission system 1 described above. FIG. 2A is a front view. FIG. 2B is a perspective view illustrating a connecting part 14 and the semiconductor package 12 mounted on the circuit board 10 (10A). These figures illustrate a dielectric waveguide 21E as an example of the dielectric waveguide 21 described above. FIG. 2C is a perspective view illustrating the dielectric waveguide 21E, and a first circuit board 10 (10A); and a second circuit board 10 (10B) is omitted. FIG. 2D is a cross-sectional view of a transmission system obtained from the cross-section illustrated by the IId-IId line illustrated in FIG. 2C

In the description below, the directions illustrated by Z1 and Z2 in FIG. 2A are respectively called upward and downward. In addition, the directions illustrated using Y1 and Y2 in FIG. 2C are respectively called forward and backward and the directions illustrated by X1 and X2 are respectively called right and left.

As illustrated in FIG. 2A, with the signal transmission system 1a, the two circuit boards 10 may be arranged facing each other. Semiconductor packages 12 are mounted on each of the circuit boards 10. The two semiconductor packages 12 are facing each other in a direction perpendicular to the circuit boards 10. Furthermore, the dielectric waveguide 21E is arranged between the two semiconductor packages 12.

As illustrated in FIG. 2B and FIG. 2D, the antenna 12e is formed on the surface of the semiconductor package 12 (package surface). As the example illustrates in the figure, the antenna 12e is formed in the center of the package surface 12f but is not limited to this position. The antenna 12e may be formed, for example, near a corner of package surface 12f. The semiconductor package 12 has an IC chip 12 h (see FIG. 2D) on which an RF circuit is formed, and a mold resin 12g covering the IC chip 12h. The antenna 12e is formed on the package surface 12f that is the surface of this mold resin 12g. Note that a protective layer for protecting the antenna 12e may be present on the surface of the antenna 12e to the extent losses are not affected.

As illustrated in FIG. 2D, the dielectric waveguide 21E has a surface 21a (waveguide end surface) facing the antenna 12e. An air gap G is ensured between the waveguide end surface 21a and the antenna 12e. Compared to a structure with the antenna 12e in contact with the waveguide end surface 21a, for example, this air gap G enables reducing energy losses for signals between the antenna 12e and the waveguide end surface 21a.

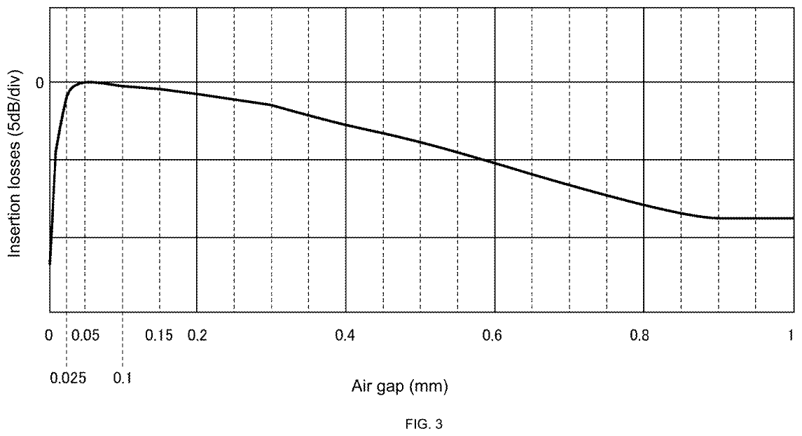

FIG. 3 is a graph illustrating the relationship between an air gap and insertion losses. The horizontal axis is the air gap and the vertical axis is insertion losses. This graph indicates higher insertion losses in the downward direction of the vertical axis. In addition, “air gap: 0 mm” on the horizontal axis of the graph indicates that the antenna 12e is in contact with the waveguide end surface 21a.

Even if the size (cross-sectional area) of the dielectric waveguide is designed in conjunction with a signal frequency (for example 60 GHz) to be transmitted via the dielectric waveguide, the frequency where actual reflection losses are minimized may be at a frequency slightly offset from that frequency (for example, 61 GHz or 62 GHz). Here, first the inventors measured the frequency where the reflection losses in the signal transmission system 1a were minimized. Furthermore, the relationship between the air gap G and insertion losses was calculated using a simulation for the case of the frequency that minimizes reflection losses being transmitted from the first semiconductor package 12 to the second semiconductor package 12 via the dielectric waveguide 21E. The inventors performed this manner of simulation on a plurality of frequencies within the range of 60 GHz to 300 GHz. FIG. 3 schematically illustrates the results thereof. In this figure, the horizontal axis is the air gap. The vertical axis represents insertion losses, with the smallest insertion loss being 0 dB. Insertion losses increase going downward on the vertical axis. As illustrated in this figure, it can be seen that insertion losses are relatively large at “air gap: 0 mm”. In addition, insertion losses abruptly decrease as the air gap G is increased from 0 mm and it can be seen that insertion losses are minimized in the air gap range of from 0.025 mm to 0.1 mm. In addition, in the range of the air gap being increased beyond 0.1 mm, insertion losses gradually increase as the air gap G gets larger. The same trend was found in the relationship of the air gap G and the insertion losses for all frequencies.

Therefore, the air gap G is preferably 0.025 mm or more. This can reduce insertion losses. The air gap G may more preferably be 0.05 mm or more. Thus, the air gap G is more reliably ensured enabling reducing the effect of tolerance of the dielectric waveguide and the circuit board on insertion losses. The air gap G may even more preferably be 0.1 mm or more. Thus, the effect of tolerance of the dielectric waveguide and the circuit board on insertion losses can be reliably reduced. In addition, the air gap G is preferably 0.8 mm or less. Thus relative positioning accuracy between the antenna 12e and the waveguide end surface 21 can be ensured and increase in insertion losses due to an excessive air gap G can be suppressed. The air gap G is even more preferably 0.5 mm or less. Thus, relative positioning accuracy of the antenna 12e and the waveguide end surface 21 can be enhanced and increase in insertion losses can effectively be suppressed.

As illustrated in FIG. 2B and FIG. 2D, the dielectric waveguide 21E may include the support part 21b for supporting the dielectric waveguide 21E on the circuit board 10. The support part 21b is directly or indirectly attached to the circuit board 10 and ensures the air gap G between the antenna 12e and the waveguide end surface 21a.

The support part 21b may be integrally formed, for example, with the dielectric waveguide 21E. In other words, for example, the support part 21b is not mutually connected to the dielectric waveguide 21E or another portion (waveguide main body 21f positioned between the two antennas 12e) by screws or the like but is mutually connected based on the chemical properties of the materials. The support part 21b and the waveguide main body 21f may be formed using a mold process of supplying molten material to a mold corresponding to the shapes thereof. Compared to a structure of mutual connection using screws or the like, this manner of structure of the dielectric waveguide 21E enables reducing the component count as well as simplifying the manufacturing process of the signal transmission system 1a.

The dielectric waveguide 21E may, for example, include two support parts 21b. The two support parts 21b may be arranged in a direction along the circuit board 10 on mutually opposite sides of the semiconductor package 12. Thus, support stability of the dielectric waveguide 21E can be ensured.

Note that unlike the example illustrated in the figure, the dielectric waveguide 21E may include four support parts 21b. Furthermore, two support parts 21b may be arranged on mutually opposite sides in a first direction (for example, left-right direction) and the remaining two support parts 21b may be arranged on mutually opposite sides in a second direction (for example, front-to-back direction). In still another example, the dielectric waveguide 21E may include a wall part surrounding the entire periphery of the semiconductor package 12 as the support part 21b. Furthermore, this wall part may be secured to the circuit board 10.

As illustrated in FIG. 2B and FIG. 2C, a connecting part 14 that connects to the dielectric waveguide 21E is mounted on the circuit board 10. In the examples illustrated in these figures, on the circuit board 10, there are two connecting parts 14 mounted in positions on mutually opposite sides of the semiconductor package 12. The dielectric waveguide 21E is mated between these two connecting parts 14 and is retained by these connecting parts 14.

As illustrated in FIG. 2D, an engaging part 14a may be formed on the connecting part 14. The engaging parts 14a may be formed on the inside of the two connecting parts 14, in other words, facing the semiconductor package 12. The engaging part 14a engages with the support part 21b of the dielectric waveguide 21E and retains the dielectric waveguide 21E on the circuit board 10. The engaging parts 14a are formed elastically deformable, for example, in the directions that the two connecting parts 14 face. The two support parts 21b of the dielectric waveguide 21E may be retained by the elasticity of the engaging parts 14a. In addition, a protruding part may be formed on the engaging part 14a. A recessed part in which the protruding part of the engaging part 14a is mated may be formed on the support part 21b.

As illustrated in FIG. 2C, the connecting part 14 may include a mounting fitting 14b formed, for example, of metal. This mounting fitting 14b may be soldered to the circuit board 10. The connecting part 14 may include a resin part 14c (see FIG. 2D). The mounting fitting 14b may be secured to the resin part 14c.

As illustrated in FIG. 2D, when the support part 21b of the dielectric waveguide 21E is mated with the engaging part 14a of the connecting part 14, the end surface of the support part 21b may be in contact with the surface of the circuit board 10. In this case, the length of the support part 21b (distance from the waveguide end surface 21a to the end surface of the support part 21b) may be set such that an appropriate air gap G is obtained.

Unlike the example illustrated in FIG. 2D, when the support part 21b of the dielectric waveguide 21E is mated with the engaging part 14a of the connecting part 14, a gap may be present between the end surface of the support part 21b and the front surface of the circuit board 10. In this case, the distance in the vertical direction from the portion coupled with the engaging part 14a (recessed part in example illustrated in the figure) to the waveguide end surface 21a may be set such that an appropriate air gap G is obtained.

Unlike the examples illustrated in FIG. 2A to FIG. 2D, for the signal transmission system 1a, the two connecting parts 14 may be integrally molded so as to surround the semiconductor package 12. In other words, the connecting part 14 may have a form of wholly surrounding the semiconductor package 12. Furthermore, two or four engaging parts 14a may be formed on portions of the connecting part 14 mutually facing the semiconductor package 12.

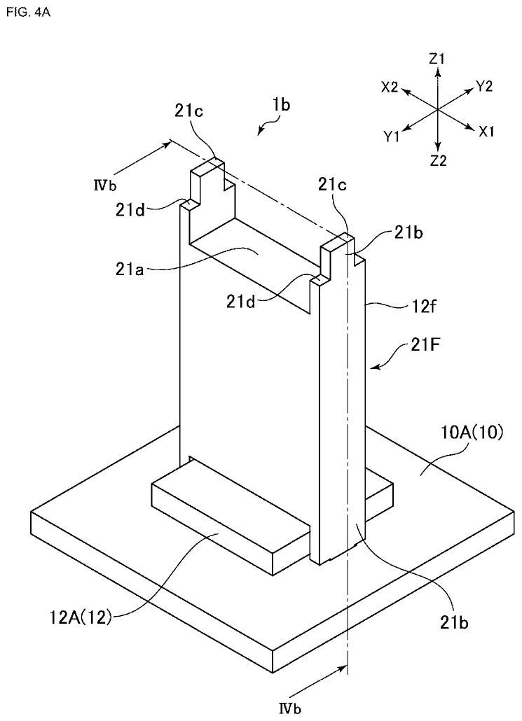

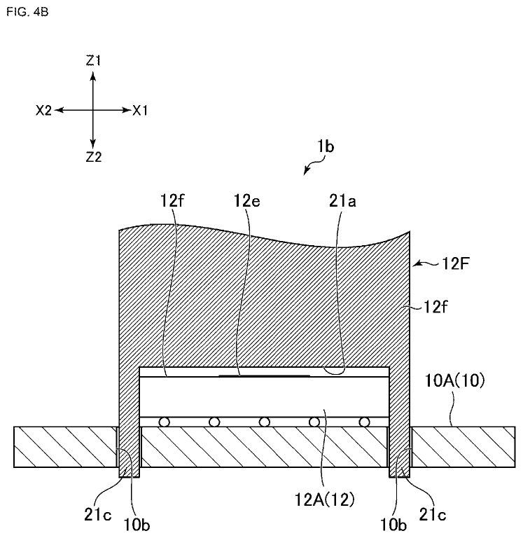

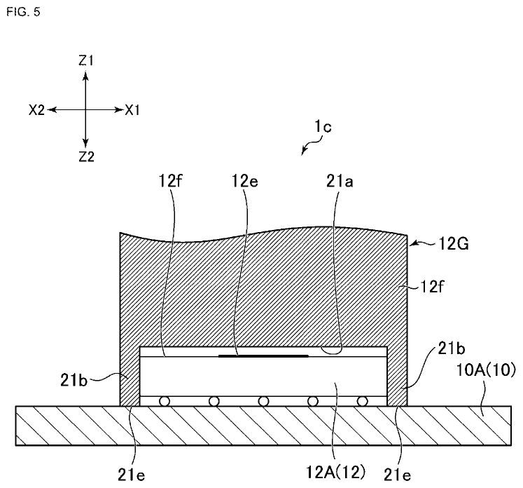

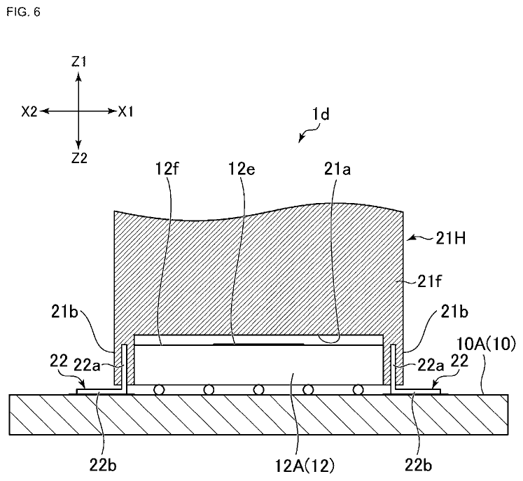

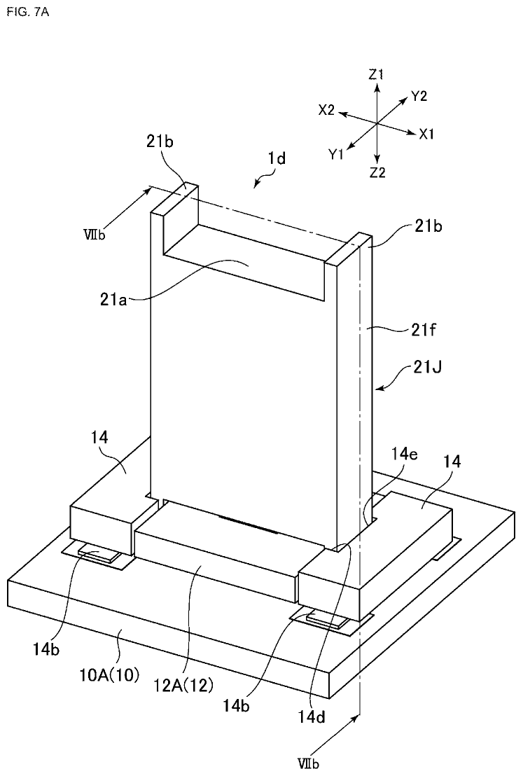

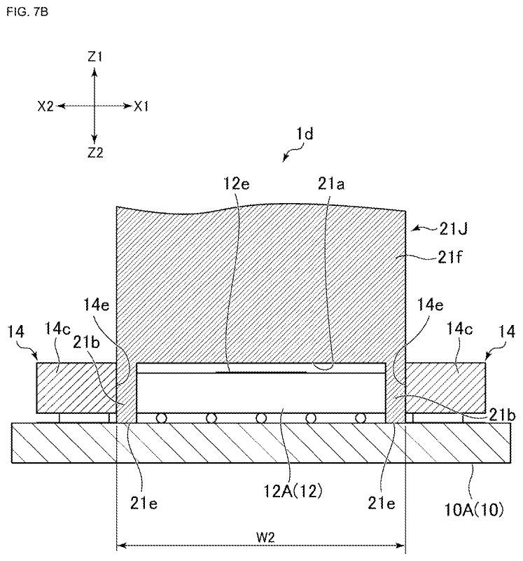

FIG. 4A to FIG. 4C, FIG. 5, FIG. 6, FIG. 7A, and FIG. 7B are figures illustrating signal transmission systems that are Modified Examples of the signal transmission system. In these figures, the same elements as those in the signal transmission system described with reference to FIG. 1 and FIG. 2A are given the same code. Hereinafter, primarily differences with the signal transmission system and the dielectric waveguide described so far will be described. Points in the examples illustrated in FIG. 4A to FIG. 4C, FIG. 5, FIG. 6, FIG. 7A, and FIG. 7B without a description may be the same as the examples described so far.

In the description below, the directions illustrated as Z1 and Z2 are respectively called upward and downward, the directions illustrated as Y1 and Y2 are respectively called forward and backward, and the directions illustrated as X1 and X2 are respectively called right and left.

FIG. 4A is a perspective view illustrating a dielectric waveguide 21F that is an example of the dielectric waveguide 21 and the first circuit board 10 (10A). In this figure, the second circuit board 10 (10B) is omitted. FIG. 4B is a cross-sectional view of the transmission system obtained from the cross-section indicated by the IVb-IVb line illustrated in FIG. 4A.

As illustrated in FIG. 4A, the dielectric waveguide 21F has two support parts 21b similar to the dielectric waveguide 21E illustrated in FIG. 2A and the like. The support part 21b has a mating part 21c protruding toward the circuit board 10. A connecting hole 10b having a size corresponding to the mating part 21c is formed in the circuit board 10. The mating part 21c fits inside and is retained in the connecting hole 10b (see FIG. 4B). The mating part 21c may be press fit into the connecting hole 10b.

As illustrated in FIG. 4A, the support part 21b may have an end surface 21d adjacent to the base part of the mating part 21c. When the mating part 21c is mated inside the connecting hole 10b, the end surface 21d faces the front surface of the circuit board 10. The end surface 21d may be in contact with the front surface of the circuit board 10. In this case, the distance from the waveguide end surface 21a to the end surface 21d may be set so as to obtain an appropriate air gap G.

FIG. 5 is a cross-sectional view of a dielectric waveguide of yet another example of a signal transmission system, and the cross-section is the same as that of FIG. 4B. In the signal transmission system 1c illustrated in FIG. 5, a dielectric waveguide 21G includes two support parts 21b similar to the dielectric waveguide 21E illustrated in FIG. 2A and the like. Adhesive may be coated on an end surface 21e of the support part 21b or the front surface of the circuit board 10 to adhere the two together. Note that this manner of adhesive may be applied to the support part 21b of the dielectric waveguide 21F illustrated in, for example, FIG. 4A and FIG. 4B.

FIG. 6 is a cross-sectional view of a dielectric waveguide of yet another example of a signal transmission system, and the cross-section is the same as that of FIG. 4B. In the signal transmission system 1d illustrated in FIG. 6, a dielectric waveguide 21H includes two support parts 21b similar to the dielectric waveguide 21E illustrated in FIG. 2A and the like. A mounting fitting 22 formed of metal may be attached to the support part 21b. The mounting fitting 22 may be soldered to the circuit board 10. The mounting fitting 22 includes a first portion 22a mounted to the support part 21b and a second portion 22b soldered to the circuit board 10. A hole may be formed in the support part 21b and the first portion 22a may be press fit into this hole. In addition, as another example, the mounting fitting 22 may be integrally molded with the dielectric waveguide 21H. In other words, in a molding process of the dielectric waveguide 21H, the mounting fitting 22 may be arranged in a mold and thereafter molten resin that is the material of the dielectric waveguide 21H may be formed. With this method, the resin that is the material of the dielectric waveguide 21H enters the hole formed in the first portion 22a of the mounting fitting 22 of the recessed part formed at the edge of the first portion 22a. Thus, the mounting fitting 22 can be retained by the dielectric waveguide 21H. The first portion 22a and the second portion 22b may be formed, for example, in an L shape. The second portion 22b may be arranged parallel to the circuit board 10 and then soldered.

FIG. 7A is a perspective view illustrating a dielectric waveguide 21J that is an example of the dielectric waveguide 21 and the first circuit board 10 (10A). In this figure, the second circuit board 10 (10B) is omitted. FIG. 7B is a cross-sectional view of a transmission system 1d obtained from the cross-section indicated by the VIIb-VIIb line illustrated in FIG. 7A.

Similar to the example illustrated in FIG. 2A, on the circuit board 10, two connecting parts 14 are mounted facing each other with the semiconductor package 12 interposed therebetween. A dielectric waveguide 21J is fitted between the two connecting parts 14. The spacing W2 of the two connecting parts 14 (see FIG. 7B) corresponds to the width of the dielectric waveguide 21J. The dielectric waveguide 21J is press fit between the two connecting parts 14 and is retained by these two connecting parts 14.

As illustrated in FIG. 7A, the two connecting parts 14 include a mating part 14e on the inside thereof, in other words, on the side thereof facing the semiconductor package 12. The support part 21b of each dielectric waveguide 21J is mated into the mating part 14e. The distance W2 of the inner surface of the mating part 14e (see FIG. 7B) corresponds to the width of the two support parts 21b. As a result, the support part 21b is press fit inside the two mating parts 14e and is retained by the connecting parts 14. In this manner, the position of the dielectric waveguide 21J is defined by the directions that the two connecting parts 14 face. In addition, the dielectric waveguide 21J in the direction orthogonal relative to the direction in which the two connecting parts 14 face each other is defined by the edge 14d of the mating part 14e.

The connecting part 14 illustrated in this figure may also include the mounting fitting 14b formed, for example, of metal. This mounting fitting 14b may be soldered to the circuit board 10. The connecting part 14 may include a resin part 14c. The mounting fitting 14b may be secured to the resin part 14c.

As illustrated in FIG. 7B, when the support part 21b of the dielectric waveguide 21J is retained by the two connecting parts 14, the end surface 21e of the support part 21b may be in contact with the front surface of the circuit board 10. In this case, the length of the support part 21b (distance in the vertical direction from the waveguide end surface 21a to the end surface 21e of the support part 21b) may be set such that an appropriate air gap G is obtained.

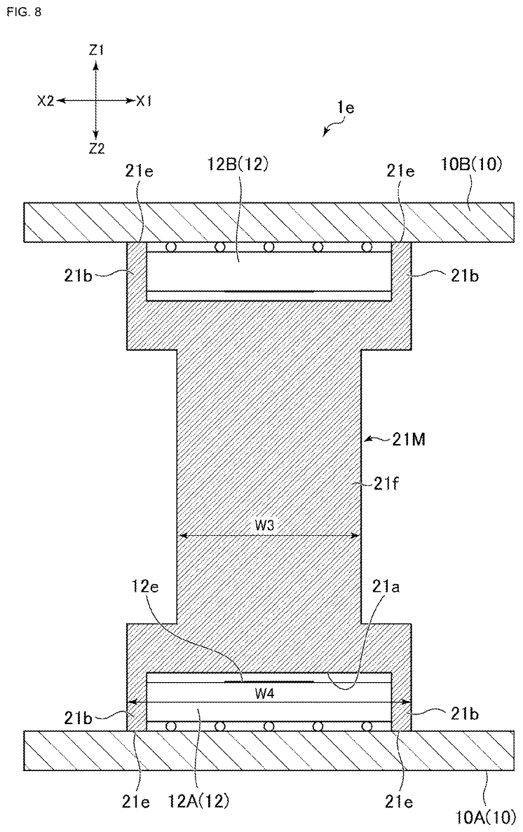

FIG. 8 is a cross-sectional view illustrating a Modified Example of the dielectric waveguide and the cross-section is similar to that of FIG. 4B. A dielectric waveguide 21M illustrated in FIG. 8 includes two support parts 21b positioned on mutually opposite sides of the semiconductor package 12 similar to the dielectric waveguide 21E illustrated in FIG. 2A and the like. As illustrated in FIG. 8, a width W3 of the waveguide main body 21f is different than a width W4 of the two support parts 21b. More specifically, the width W3 of the waveguide main body 21f may be smaller than the width W4 of the two support parts 21b. With this structure, the width W4 of the support part 21b can be adapted to the size of the semiconductor package 12 while the width W3 of the waveguide main body 21f can be a size that is adapted to the frequency of the electromagnetic waves transmitted and received between the two semiconductor packages 12.

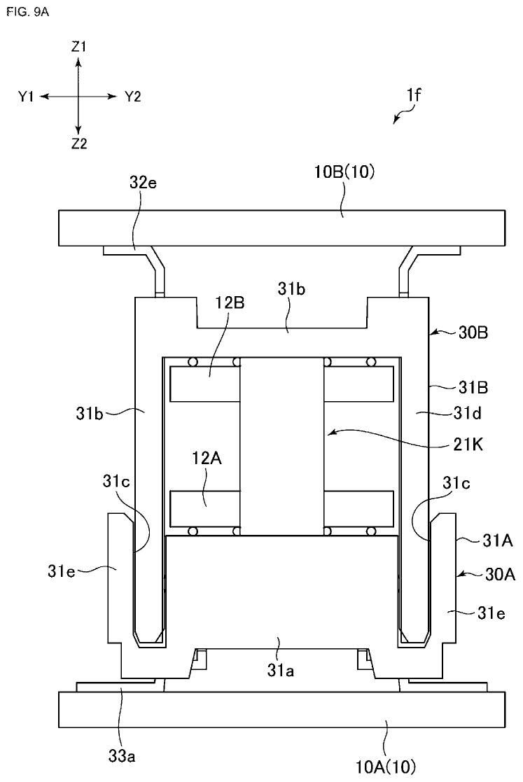

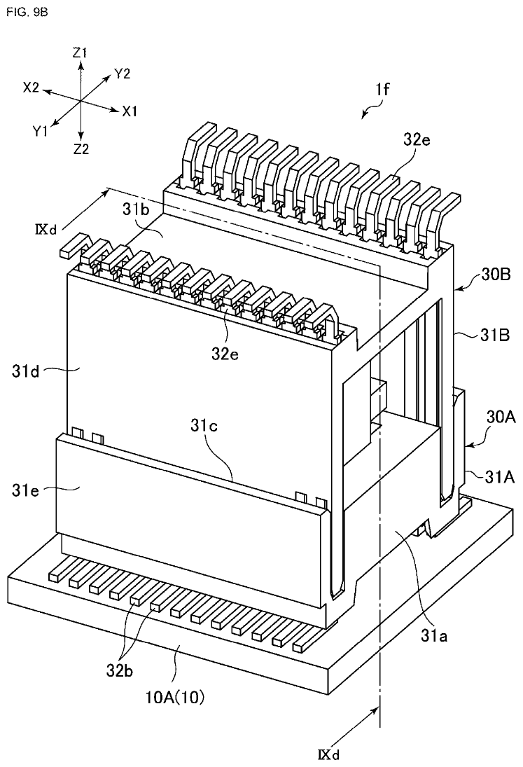

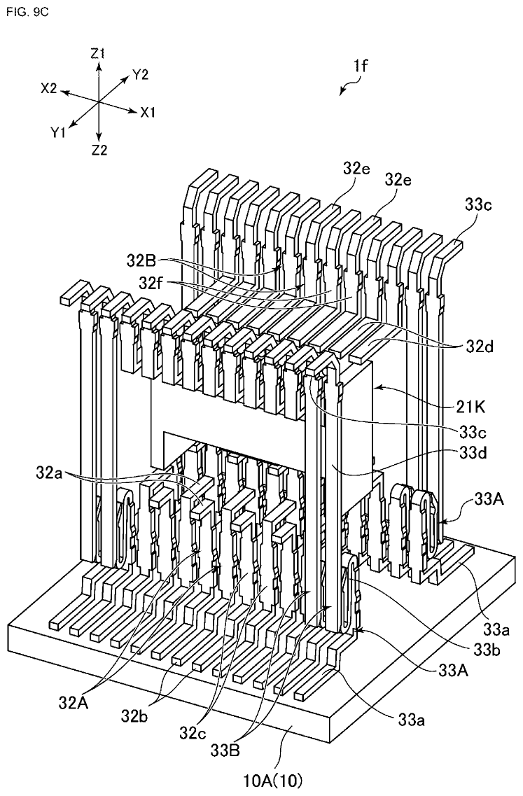

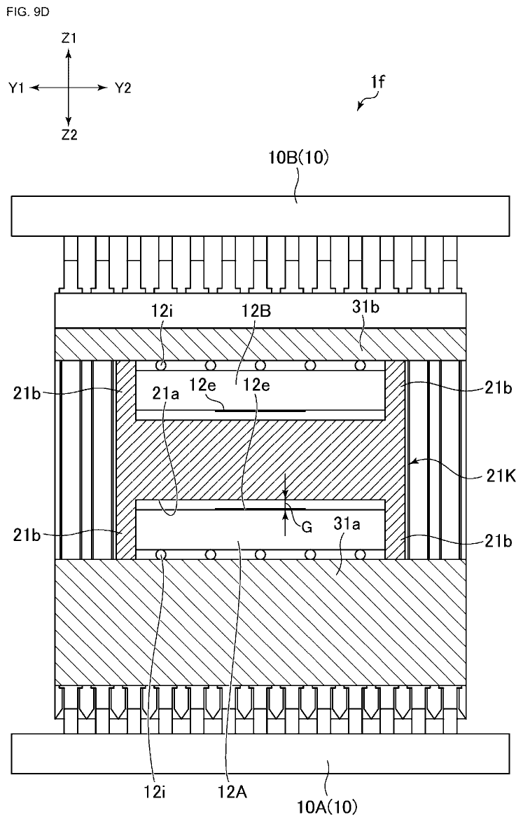

FIG. 9A to FIG. 9D illustrate yet another example of a signal transmission system. The same codes are assigned to the same elements in the signal transmission systems described in the figures so far. Hereinafter, primarily differences with the signal transmission system described so far will be described.

FIG. 9A is a side view of the signal transmission system if. FIG. 9B is a perspective view of a signal transmission system 1f and in this figure, the second circuit board 10B is omitted. FIG. 9C is a perspective view of the arrangement of the relay fittings 32A and 32B included in the connectors 30A and 30B included in the signal transmission system if. FIG. 9D is a cross-sectional view of a transmission system obtained from the cross-section illustrated by the VIIId-VIIId line illustrated in FIG. 9B Points in the examples illustrated in FIG. 9A to FIG. 9D without a description may be the same as the examples described so far.

As illustrated in FIG. 9A, the signal transmission system 1f may include two connectors 30A and 30B mounted respectively on the circuit boards 10A and 10B. The first connector 30A is mounted on the first circuit board 10A arranged on the lower side. The first connector 30A may include housing 31A, relay fitting 32A (see FIG. 9C), and semiconductor package 12A. The second connector 30B is mounted on the second circuit board 10B arranged on the upper side. Similar to the first connector 30A, the second connector 30B may also include housing 31B, relay fitting 32B (see FIG. 9C), and semiconductor package 12B. A dielectric waveguide 21K is arranged between and retained by the two connectors 30A and 30B.

As illustrated in FIG. 9A, the housings 31A and 31B include pedestals 31a and 31b, respectively. The semiconductor package 12A is arranged on the upper surface (surface facing the second circuit board 10B) of the pedestal 31a in the first connector 30A. The semiconductor package 12B is arranged on the lower surface (surface facing the first circuit board 10A) of the pedestal 31b in the second connector 30B.

As illustrated in FIG. 9A, a dielectric waveguide 21K is arranged between the two pedestals 31a and 31b. The dielectric waveguide 21K includes two support parts 21b on the upper end and on the lower end respectively (see FIG. 9D) similar to the dielectric waveguide 21E. The two support parts 21b formed on the end part (lower end) on the first connector 30A are arranged on opposite sides of the semiconductor package 12A. The two support parts 21b formed on the end part (upper end) of the second connector 30B are also arranged on opposite sides of the semiconductor package 12B. The support part 21b on the upper end and the support part 21b on the lower end may be formed so as to surround the entire circumference of the semiconductor packages 12A and 12B.

As illustrated in FIG. 9D, the support part 21b on the first connector 30A side is supported on the front surface of the pedestal 31a. The support part 21b on the second connector 30B is supported on the front surface of the pedestal 31b. Various structures can be used as the fixed structure of the support part 21b and the pedestals 31a and 31b. For example, the end surface of the support part 21b can be adhered to the front surface of the pedestals 31a and 31b using adhesive. Alternatively, the mounting fitting 22 illustrated in FIG. 6 may be mounted on the support part 21b and this mounting fitting 22 may be soldered to a metal part formed on the pedestals 31a and 31b.

As illustrated in FIG. 9D, an air gap G is formed between the waveguide end surface 21a of the dielectric waveguide 21K and the antenna 12e of the semiconductor package 12A. This air gap G may be defined by the length of the support part 21b.

The housing 31A of the first connector 30A and the housing 31B of the second connector 30B may be formed to mutually mate and to restrict relative movement. Thereby, the relative position between the dielectric waveguide 21K and the antenna 12e can also be appropriately maintained.

As an example, an insertion part 31d may be formed on the housing 31B of the second connector 30B extending downward toward the first circuit board 10A as illustrated in FIG. 9A. The housing 31B of the second connector 30B may include two insertion parts 31d positioned on mutually opposite sides of the semiconductor package 12B (in other words, opposite sides of the pedestal 31b). In addition, the housing 31A of the first connector 30A may have an opening receiving part 31c formed facing the second circuit board 10B. The housing 31A of the first connector 30A may have two receiving parts 31c positioned on mutually opposite sides of the semiconductor package 12A (in other words, opposite sides of the pedestal 31a). The insertion part 31d mates with the receiving part 31c. This restricts relative movement of the two connectors 30A and 30B. More specifically, relative movement of the connectors 30A and 30B in the front-to-back direction is restricted by the insertion part 31d and the receiving part 31c.

In the example illustrated in FIG. 9A, regarding the receiving part 31c, the gap formed between an outer wall part 31e and the side surface of the pedestal 31a functions as the receiving part 31c. The receiving part 31c is also open in the left-right direction (direction aligned with the relay fittings 32A and 32B) rather than upward. The shape of the receiving part 31c is not limited to this. The receiving part 31c may be formed so as to surround the entirety of each insertion part 31d. In other words, the left end and right end of the receiving part 31c may be closed.

As illustrated in FIG. 9D, the semiconductor package 12A mounted on the first connector 30A includes a plurality of connecting terminals 12i on the bottom surface thereof (surface opposite the package surface 12f). The connecting terminals 12i connect to the IC chip 12 h (see FIG. 2D) incorporated in the semiconductor package 12A. The connecting terminals 12i of the semiconductor package 12A are, for example, soldered to a first connecting part 32a of the relay fitting 32A (see FIG. 9C). In addition, the semiconductor package 12B of the second connector 30B also includes a plurality of connecting terminals 12i (see FIG. 9D) on the upper surface thereof (surface opposite the package surface 12f). These connecting terminals 12i are, for example, soldered to a first connecting part 32d (see FIG. 9C) of the relay fitting 32B retained by the pedestal 31b of the housing 31B.

The first connecting part 32a of the relay fitting 32A is exposed on the front surface of the pedestal 31a. As illustrated in FIG. 9C, the relay fitting 32A includes a second connecting part 32b soldered to a conductive pad (not shown) formed on the first circuit board 10A. In addition, the relay fitting 32A includes a center section 32c extending from the first connecting part 32a in the mating direction of the two connectors 30A and 30B, in other words, the direction orthogonal to the circuit boards 10A and 10B in the example illustrated in the figure.

The first connecting part 32d of the relay fitting 32B is exposed on the front surface of the pedestal 31b. As illustrated in FIG. 9C, the relay fitting 32B includes a second connecting part 32e soldered to a conductive pad (not shown) formed on the second circuit board 10B. In addition, the relay fitting 32B includes a center section 32f extending from the first connecting part 32d in the mating direction of the two connectors 30A and 30B, in other words, the direction orthogonal to the circuit boards 10A and 10B in the example illustrated in the figure.

The relay fittings 32A and 32B are retained by the housings 31A and 31B. In a first example, the relay fittings 32A and 32B are integrally formed with the housings 31A and 31B. In other words, the relay fittings 32A and 32B may be arranged in the mold during the molding process of the housings 31A and 31B. Thereafter, the molten resin that is the material of the housings 31A and 31B may be formed. This method enables the material of housings 31A and 31B material to enter holes formed in the center sections 32c and 32f of the relay fittings 32A and 32B or recessed parts formed on the edges of the center sections 32c and 32f. Thus, the relay fittings 32A and 32B are retained by the housings 31A and 31B. Alternatively, the relay fittings 32A and 32B may be press fit into the housings 31A and 31B.

The relay fittings 32A and 32B are formed of metal. The material of the relay fittings 32A and 32B may be, for example, brass or phosphor bronze. The relay fittings 32A and 32B may be formed using press forming such as bending or punching. The housings 31A and 31B may be formed of resin. The material of the housings 31A and 31B may be, for example, polybutylene terephthalate (PBT) or polyamide (PA).

High frequency signals are transmitted and received between electronic components and sensors mounted on the two circuit boards 10A and 10B via the relay fittings 32A and 32B, semiconductor packages 12A and 12B, the antenna 12e, and dielectric waveguide 21K.

As illustrated in FIG. 9C, the first connector 30A may include a connecting terminal 33A and the second connector 30B may include a connecting terminal 33B. The two connecting terminals 33A and 33B may be in direct contact with each other. With the connecting terminals 33A and 33B, low frequency signals and direct current can be transmitted and received between the two circuit boards 10A and 10B without passing through the dielectric waveguide 21K.

The connecting terminal 33A includes a connecting part 33a soldered on the first circuit board 10A and a plate spring contact part 33b. On the other hand, the connecting terminal 33B includes a connecting part 33c soldered on the second circuit board 10B and a contact part 33d extending from the connecting part 33c toward the first circuit board 10A. The connecting terminals 33A and 33B may be mutually in contact with the contact parts 33b and 33d. The connecting terminal 33A is retained by the housing 31A together with the relay fitting 32A. In addition, the connecting terminal 33B is retained by the housing 31B together with the relay fitting 32B.

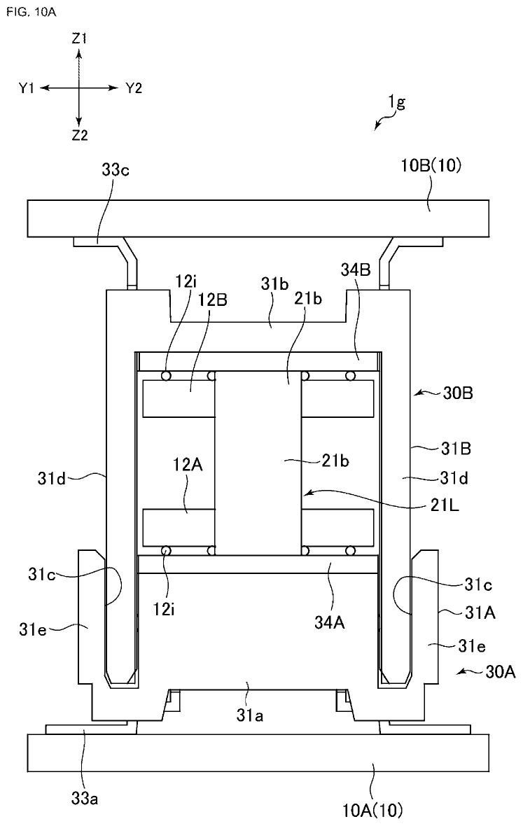

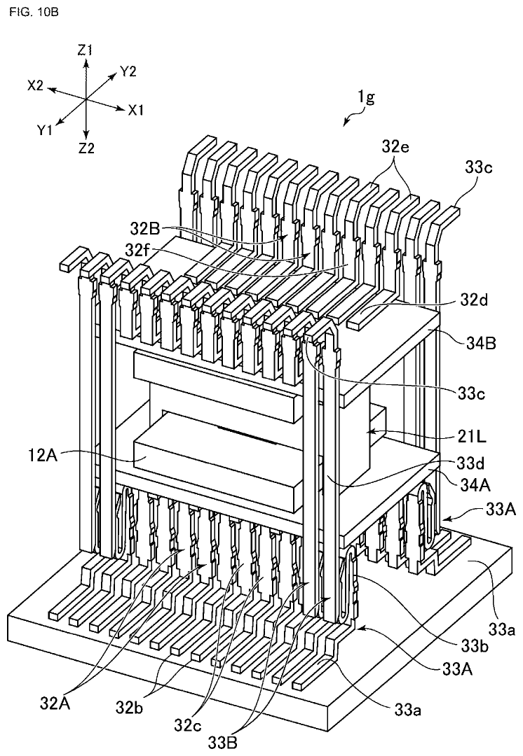

FIG. 10A and FIG. 10B illustrate yet another example of a signal transmission system. The same codes are assigned to the same elements in the signal transmission systems described in the figures so far. Hereinafter, primarily differences with the signal transmission system 1f described with reference to FIG. 9A to FIG. 9D will be described.

FIG. 10A is a side view of a signal transmission system 1g. FIG. 10B is a perspective view of the arrangement of the relay fittings 32A and 32B included in the connectors 30A and 30B of the signal transmission system 1g. Points in the examples illustrated in FIG. 10A and FIG. 10B without a description may be the same as the examples described so far.

As illustrated in FIG. 10A, the first connector 30A may include an interposer board 34A. The interposer board 34A is arranged on the pedestal 31a of the housing 31A. The semiconductor package 12A is arranged on the interposer board 34A. A conductive pattern (circuit) for electrically connecting the first connecting part 32a of the relay fitting 32A and the connecting terminals 12i of the semiconductor package 12A is formed on the interposer board 34A. Use of the interposer board 34A enables raising the degree of freedom of the relay fitting 32A arrangement as well as the degree of freedom of arranging the connecting terminals 12i of the semiconductor package 12A.

In addition, as illustrated in FIG. 10A, the second connector 30B may also have an interposer board 34B. The interposer board 34B is arranged below the pedestal 31a on the housing 31B. The semiconductor package 12B may be attached to this interposer board 34B. A conductive pattern (circuit) for electrically connecting the first connecting part 32d of the relay fitting 32B and the connecting terminals 12i of the semiconductor package 12B is formed on the interposer board 34B. Use of the interposer board 34B enables raising the degree of freedom of the relay fitting 32B arrangement as well as the degree of freedom of arranging the connecting terminals 12i of the semiconductor package 12B.

A dielectric waveguide 21L may be supported by the interposer boards 34A and 34B. For example, the support part 21b of the dielectric waveguide 21L formed on the first circuit board 10A may be connected to the front surface of the interposer board 34A by adhesive, or the mounting fitting 22 illustrated in FIG. 6 may be attached to the support part 21b and this mounting fitting 22 may be soldered to the interposer board 34A. In a similar manner, the support part 21b of the dielectric waveguide 21L formed on the second circuit board 10B may be connected to the front surface of the interposer board 34B by adhesive, or the mounting fitting 22 illustrated in FIG. 6 may be attached to the support part 21b and this mounting fitting 22 may be soldered to the interposer board 34B.

Note that unlike the examples illustrated in FIG. 10A and FIG. 10B, of the two connectors 30A and 30B, an interposer board may be included on only one of the connectors. For example, the interposer board 34A may be included on only the first connector 30A. In this case, the support part 21b of the dielectric waveguide 21L formed on the first circuit board 10A may be the one attached to the interposer board 34A and the support part 21b of the dielectric waveguide 21L formed on the second circuit board 10B may be attached to the pedestal 31b of the housing 31B.

As has been described above, the signal transmission systems 1a to 1g include the circuit boards 10A and 10B, and semiconductor packages 12A and 12B containing an RF circuit and the dielectric waveguides 21, 21E, 21F, 21G, 21H, 21J, 21K, and 21L mounted on the circuit boards 10A and 10B. The semiconductor packages 12A and 12B include the package surface 12f and the antenna 12e formed on the package surface 12f. The dielectric waveguides 21 and 21E to 21M include a waveguide end surface 21a facing the antenna 12e. An air gap G is ensured between the waveguide end surface 21a and the antenna 12e. With this system, the air gap G can reduce insertion losses.

Note that the signal transmission systems proposed in the present disclosure are not limited to those described above.

For example, a plurality of dielectric waveguides may be arranged between the circuit boards 10A and 10B. Furthermore, the signal transmission system may include a member securing the relative position of the plurality of dielectric waveguides.

1. A signal transmission system, comprising:
a circuit board;
a semiconductor package including an RF circuit mounted on a circuit board; and
a dielectric waveguide; wherein
the semiconductor package includes a package surface and an antenna formed on the package surface,
the dielectric waveguide includes a waveguide end surface facing the antenna, and
an air gap is ensured between the waveguide end surface and the antenna.

2. The signal transmission system according to claim 1, further comprising at least one support part that supports the dielectric waveguide on the circuit board and ensures an air gap.

3. The signal transmission system according to claim 2, wherein the at least one support part is formed on the dielectric waveguide.

4. The signal transmission system according to claim 2, wherein the at least one support part includes two support parts positioned on mutually opposite sides of the semiconductor package.

5. The signal transmission system according to claim 1, wherein the air gap is 0.025 mm or more and 0.8 mm or less.

6. A dielectric waveguide, comprising:
a waveguide main body;
a waveguide end surface for facing the antenna formed on the surface of a semiconductor package, which is an end surface of the waveguide main body in the extending direction of the waveguide main body; and
at least one support part extending beyond the waveguide end surface that ensures an air gap between the antenna supported on a circuit board on which the semiconductor package is mounted and the waveguide end surface.
